(19) United States
(12) Patent Application Publication
(10) Pub. No.: US 2017/0155993 A1
(43) Pub. Date: Jun. 1, 2017

(54) Wireless Earpieces Utilizing Graphene Based Microphones and Speakers

(71) Applicant: BRAGI GmbH, München (DE)

(72) Inventor: Peter Vincent Boesen, München (DE)

(21) Appl. No.: 15/362,066

(22) Filed: Nov. 28, 2016

Related U.S. Application Data
(60) Provisional application No. 62/260,954, filed on Nov. 30, 2015.

(51) Int. Cl. H04R 1/10; H04R 7/10

(52) U.S. Cl. CPC H04R 1/1016; H04R 1/1075; H04R 1/1041; H04R 7/10; H04R 2460/13; H04R 2307/023; H04R 2420/07

(57) ABSTRACT

A system, method, and wireless earpiece. The wireless earpiece includes a frame supporting circuitry of the wireless earpiece. The frame includes a graphene speaker and a graphene microphone with a sleeve portion of the frame configured to fit in to an ear canal of a user. The wireless earpiece may further include a processor for executing a set of instructions and a memory for storing the set of instructions, wherein the set of instructions are executed to process the first electronic signals for playback by the graphene speaker; and process the second electronic signals received from the graphene microphone.

### PRIORITY STATEMENT

This application claims priority to U.S. Provisional Patent Application 62/260,954, filed on Nov. 30, 2015, and entitled Earpiece utilizing Graphene Based Microphone and/or Graphene Based Speaker Method and System, hereby incorporated by reference in its entirety.

### BACKGROUND

I. Field of the Disclosure

The illustrative embodiments relate to portable electronic devices. More specifically, but not exclusively, the illustrative embodiments relate to a system, method, and device for utilizing graphene-based speakers and microphones in portable electronic devices.

II. Description of the Art

The growth of wearable devices is increasing exponentially. This growth is fostered by the decreasing size of microprocessors, circuitry boards, chips, and other components. In some cases, wearable devices may include earpieces worn in the ears of the user. The positioning of an earpiece at the external auditory canal of a user brings with it many benefits. The user is able to perceive sound directed from a speaker toward the tympanic membrane, allowing for a richer auditory experience. This may be voice content, music, or other sounds. Generating high quality sound in the earpiece may be difficult due to the range of the audio spectrum, reduced footprint for electronics, and small energy sources available. In addition, many earpieces rely on utilization of all of the available space of the external auditory canal luminal area in order to allow for stable placement and position maintenance. Due to the positioning of the earpieces within the ear canal, the components may benefit from being very small and need to be stable to prevent being damaged or destroyed by naturally secreted biological materials, such as sweat or cerumen (e.g., earwax a viscous product produced by the sebaceous glands).

### SUMMARY OF THE DISCLOSURE

One embodiment provides a system, method, and wireless earpiece. The wireless earpiece includes a frame supporting circuitry of the wireless earpiece. The frame includes a graphene speaker and a graphene microphone with a sleeve portion of the frame configured to fit in to an ear canal of a user.

Another embodiment provides a wireless earpiece. The wireless earpiece includes a frame supporting circuitry of the wireless earpiece. The wireless earpiece further includes a graphene speaker configured to convert first electronic signals to first sound waves. The wireless earpiece further includes a graphene microphone configured to convert second sound waves to second electronic signals. The wireless earpiece also includes a processor for executing a set of instructions and a memory for storing the set of instructions. The set of instructions are executed to process the first electronic signals for playback by the graphene speaker and process the second electronic signals received from the graphene microphone.

Yet another embodiment provides a method for forming a graphene speaker for a wireless earpiece. A graphene layer is created. The graphene layer is secured with a frame to form a graphene diaphragm. The graphene diaphragm is connected to a number of layers to create the graphene speaker.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial representation of a wireless earpiece and the wireless earpiece inserted in an ear of a user in accordance with an illustrative embodiment;

FIG. 2 is a pictorial representation of a graphene speaker in accordance with an illustrative embodiment:

FIG. 3 is a block diagram of wireless earpieces in accordance with an illustrative embodiment;

FIG. 4 is a flowchart of a process for generating a graphene speaker in accordance with an illustrative embodiment; and

FIG. 5 illustrates different sizes of sleeves.

### DETAILED DESCRIPTION OF THE DISCLOSURE

The illustrative embodiments provide a wireless earpiece enhanced with a graphene speaker and microphone. Graphene is an allotrope of carbon in the form of an atomic-scale, hexagonal lattice in which one atom forms each vertex. Graphene is about two hundred and seven (207) times stronger than steel by weight, conducts heat and electricity efficiently, and is nearly transparent. The graphene speakers and microphone provide a lighter and smaller footprint for wireless earpieces that effectively generate acoustic signals for the user to listen to (speaker) as well as effective detection of acoustic signals (microphone). In one embodiment, the graphene speakers and microphones may be positioned with the wireless earpieces in sets or arrays that are tuned to distinct frequencies, wavelengths, or so forth. The incredible performance characteristics of the speaker and microphone provide better sound quality both communicated and received from the user.

In one embodiment, the graphene is formed in sheets that are then shaped into cones, cylinders and others shapes that are fused or formed for utilization in the speakers and microphones of the wireless earpieces. Graphene or graphene-like structure may also be formed. In one embodiment, the graphene speakers and microphones are mounted, attached, or integrated into a framework covered by a sleeve cover of the wireless earpiece. The graphene components are light, biocompatible, and easily inserted into the wireless earpiece framework. The graphene may also be utilized to form the framework, structures, or various waveguide structures that more effectively communicate the audio waves. The waveguides are structures that guide waves, such as sound waves to propagate the signals with minimal loss of energy.

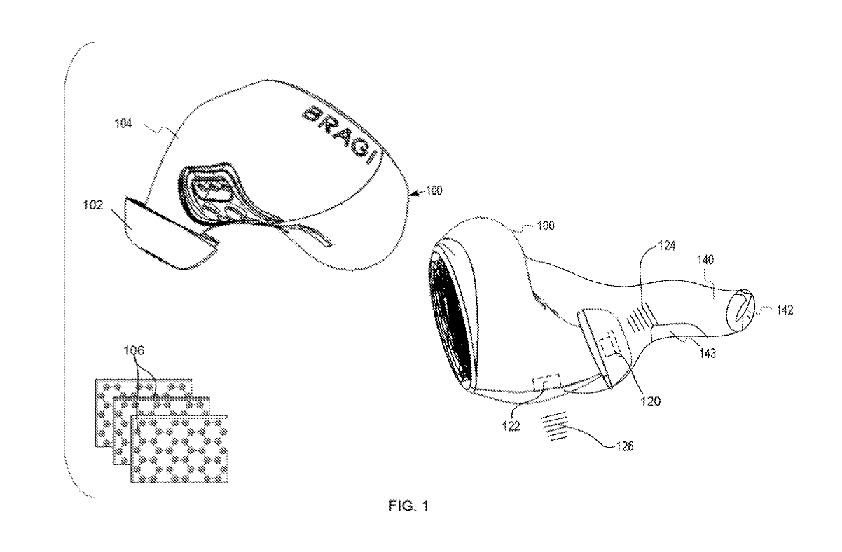

FIG. 1 is a pictorial representation of a wireless earpiece 100 in accordance with an illustrative embodiment. The wireless earpiece 100 may have any number of components and structures. In one embodiment, the portion of the wireless earpiece 100 that fits into a user's ear is referred to as a sleeve 102. The sleeve 102 may be a cover or surface, such as lightweight silicone, that fits over a portion of a frame 104 (e.g., extension) of the wireless earpiece. The sleeve 102 is configured to fit inside the user's ear. A speaker 120 may be a graphene speaker configured to play audio content of any number of frequencies. For example, the speaker 120 may include an array of graphene speakers maximized to generate audio signals 124 of a specific range. As a result, the speaker 120 may enhance music, voice content (e.g., phone calls), tones, sounds, and so forth. In another embodiment, the speaker 120 may utilize bone conduction to generate sound waves that are communicated to the inner ear. In one embodiment, the speaker 120 may include one or more graphene diaphragms for generating the audio signals. The diaphragm may be secured in a framework and driven by a driver.

The wireless earpiece 100 may also include a microphone 122. The microphone 122 may be a graphene microphone. In one embodiment, the microphone 122 may represent one or more microphones including an ear-bone microphone. The ear-bone microphone utilizes bone conduction to sense sound waves 126. Bone conduction is the conduction of sound to the inner ear through the bones of the skull. The microphone 122 may also be positioned on the exterior surface of the wireless earpiece 100) for sensing sound waves generated by the user and external factors in the environment.

In one embodiment, sheets 106 of graphene may be layered, wrapped, stacked, folded or otherwise manipulated to form all or portions of the speaker 120 and the microphone 122. The sheets 106 may be created utilizing any number of processes (e.g., liquid phase exfoliation, chemical vapor/thin film deposition, electrochemical synthesis, hydrothermal self-assembly, chemical reduction, micromechanical exfoliation, epitaxial growth, carbon nanotube deposition, nano-scale 3D printing, spin coating, supersonic spray, carbon nanotube unzipping, etc.). Graphenite, carbon nanotubes, graphene oxide hydrogels, hyper honeycomb formed of carbon atoms, graphene analogs, or other similar materials may also be utilized to form portions of the speaker 120 and the microphone 122, such as diaphragms. The sheets 106 may also be utilized to form other portions of the wireless earpiece 100.

The sheets 106 may be layered, shaped, and/or secured utilizing other components, such as adhesives, metallic bands, frameworks, or other structural components. In one embodiment, layers of graphene (e.g., the sheets 106) may be imparted, integrated, or embedded on a substrate or scaffolding that may remain or be removed to form the speaker 120, microphone 122, or one or more graphene structures of the wireless earpiece 100. In another embodiment, the sheets 106 may be reinforced utilizing carbon nanotubes. The carbon nanotubes may act as reinforcing bars (e.g., an aerogel, graphene oxide hydrogels, etc.) strengthening the thermal, electrical, and mechanical properties of the speaker 120 and the microphone 122 formed by the sheets 106.

In one embodiment, the sheets 106 of graphene may be soaked in solvent and then overlaid on an underlying substrate. The solvent may be evaporated over time leaving the sheets 106 of graphene that have taken the shape of the underlying structure. For example, the sheets 106 may be overlaid on a specially shaped frame (not shown) to form all or portions of the speaker 120, microphone 122, support structure, and/or electrical components of the wireless earpiece 100. The sheets 106 may represent entire layers, meshes, lattices, or other configurations.

The graphene portions of the speaker, microphone 122, and other components may be highly effective in protecting the functionality and structural integrity of the wireless earpiece 100 from cerumen 143. As previously noted, cerumen 143 is a highly viscous product of the sebaceous glands mixed with less-viscous components of the apocrine sweat glands. In many cases, around half of the components of cerumen 143 on a percentage basis is composed of keratin, 10-20% of saturated as well as unsaturated long-chain fatty acids, alcohols, squalene, and cholesterol. In one form, cerumen 143 is also known as earwax. The sleeve 102 channels the sound generated by one or more speakers 120 for more effective reception of the audio content 124 while protecting the wireless earpiece 100 from the hazards of internal and external materials and biomaterials. In some cases, the graphene layer(s) may include or capture and secure other materials to further strengthen the speaker 120, microphone 122, or other structures formed by the sheets 106.

FIG. 1 further illustrates the wireless earpiece 100 as inserted into an ear of an individual or user. The wireless ear piece 100 fits at least partially into the external auditory canal 140 of the user. A tympanic membrane 142 is shown at the end of the external auditory canal 140.

In one embodiment, the wireless ear piece 100 may completely block the external auditory canal 140 physically or partially block the external auditory canal 140 to more effectively communicate the audio signals 124. The wireless earpiece 100 may further amplify or pass through environmental sounds outside of the auditory canal 140 for any number of purposes (e.g., safety, awareness, games, etc.). As shown, the cerumen 143 may collect to partially block the external auditory canal 140. As a result, it is important that the speaker 120 work effectively in the presence of cerumen 143 to communicate the audio signals 124. Due to the inert and responsive properties of graphene, the speaker 120 and the microphone 122 work effectively in the presence of cerumen 143 and other biomaterials, fluids, and solids due to the responsiveness and inherent properties of graphene. For example, the wireless earpiece 100 may not be able to communicate sounds waves effectively past the cerumen 143. Thus, the ability to reproduce ambient or environmental sound captured from outside of the wireless ear piece 100 and to reproduce it within the wireless earpiece 100 may be advantageous regardless of whether the wireless earpiece 100 itself blocks or does not block the external auditory canal 140 and regardless of whether the combination of the wireless earpiece 100 and cerumen 143 impaction blocks the external auditory canal 140. It is to be further understood, that different individuals have external auditory canals of varying sizes and shapes and so the same wireless earpiece 100 configuration which completely blocks the external auditory canal 140 of one user would not necessarily block the external auditory canal of another user.

As previously noted, the sleeve 102 may be formed from one or more graphene layers. The sleeve 102 may interact with the cerumen to protect the internal components of the wireless earpiece 100 that may be shorted, clogged, blocked, or otherwise adversely affected by the cerumen 143. The sleeve 102 may be coated with silicon or other external layers that make the wireless earpiece 100 fit well and comfortable to use. The external layer of the sleeve 102 may be supported by the graphene layers, graphene mesh, graphene framework, or other structure that provides structural, electrical, and chemical stability to the wireless earpiece 100. For example, the sleeve 102 may include a graphene extension and external cover shaped and sized to fit the ear of the user.

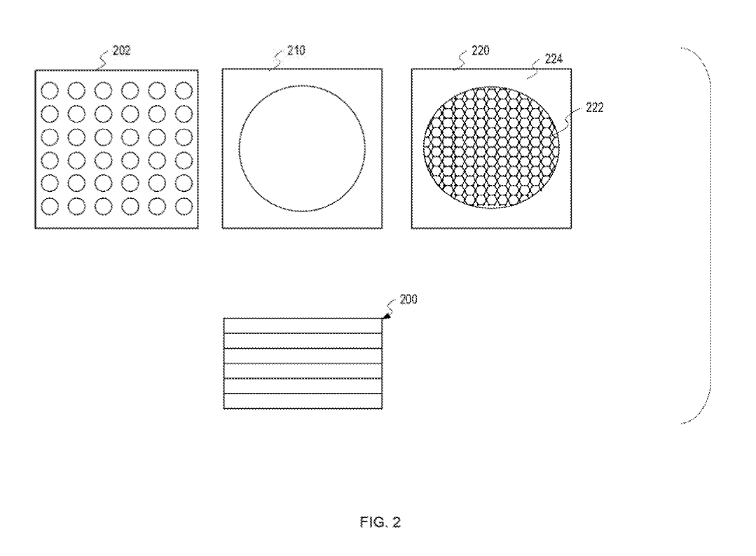

FIG. 2 is a pictorial representation of a graphene speaker 200 in accordance with an illustrative embodiment. In one embodiment, the graphene speaker 200 may include any number of layers or components (the graphene speaker 200 is shown combined and in separate layers that may be utilized to form the graphene speaker 200). For example, the graphene speaker 200 may include an electrode layer 202, a spacer layer 210, and a graphene layer 220. The layers of the graphene speaker 200 may be deposited, combined, or otherwise combined in any order. The layers may also be duplicated or repeated as needed to achieve the desired result.

In one embodiment, the electrode layer 202 may include any number of contacts, wires, traces, or other components for electrically connecting portions of the graphene speaker. The electrode layer 202 may also include any number of amplifiers, signal generators, sound coils, magnets, and so forth.

The spacer layer 210 may separate the electrode layer 202 from the graphene layer 220. The spacer layer 210 may isolate the graphene layer 220 to further enhance the sounds waves generated and prevent unwanted electrical or sound noise. In some embodiments, the spacer layer 210 may not be utilized or may be a portion of the electrode layer 202. The spacer layer 210 may also be a wave guide that channels waves into the ear of the user.

In one embodiment, an electrical signal is applied to the graphene layer 220. The graphene layer 220 includes a graphene diaphragm 222 secured by a frame 224. The graphene diaphragm 222 may be circularly shaped. However, in other embodiments the graphene diaphragm 222 may be elliptical, square, oblong, rectangular, hexagonal, or any number of other custom or pre-defined shapes. The graphene layer 220 may act as a driver for converting the electrical audio signals into sound waves.

The frame 224 may include a number of electrodes for applying an electrical signal to the graphene diaphragm 222 that is then converted to sound waves by the graphene diaphragm 222. For example, the electrodes may be positioned proximate a first and second side of the graphene membrane. In one embodiment, an electrical signal is applied to the graphene diaphragm 222 to generate sounds waves that are then propagated through a wave guide to the ears of the user. The graphene diaphragm 222 may be one or more layers of graphene that are layered to produce the desired sound waves. In other embodiments, the graphene diaphragm 222 may include other compounds, substrates or layers. Although not shown, the graphene speaker 200 or a separate speaker may include a number of graphene diaphragms configured to generate sounds waves at distinct frequency ranges (e.g., bass, woofer, tweeter, midrange, etc.). As a result, performance of the graphene speaker 200 is enhanced. The performance of the graphene speaker 200 may be extremely energy efficient and effective based of the rigidity, conductivity, and weight properties of graphene. For example, in some tests graphene membranes, such as the graphene diaphragm 222, have been shown to efficiently convert 99% of the driving energy for the graphene speaker 200 to sound waves. The frequency responses are also sharp and more accurate than traditional forms of speakers/diaphragms. The high fidelity reproduction of sound of the graphene speaker 200 may be based on the frequency response characteristics of the graphene diaphragm 222.

In another embodiment, the graphene speaker 200 may with minor modifications represent a graphene microphone. For example, a graphene microphone may detect vibrations or sound waves in the graphene diaphragm 222. The vibrations of the graphene diaphragm 222 may be converted to electrical signals representing the sounds waves that may be then communicated through the wireless earpiece (e.g., to a processor) and to any number of other components. In one embodiment, the graphene diaphragm 222 may be placed in front of a charged plate to sense vibrations in the graphene diaphragm. In another embodiment, the graphene diaphragm 222 of the graphene microphone may be glued to or integrated with a magnetic coil. The graphene microphone may work through ear-bone conduction or in air transmissions of sound waves.

The graphene speaker 200 may include the electrode layer 202, a spacer layer 210, and a graphene layer 220, followed by another spacer layer, another electrode layer, and any number of housings for securing the layers or components of the graphene speaker 200 to each other.

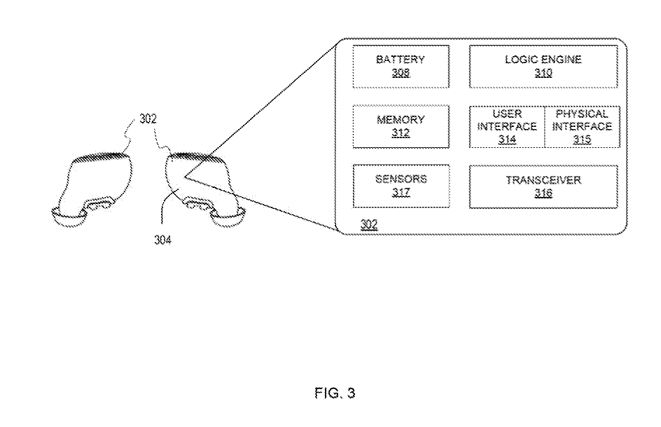

FIG. 3 is a block diagram of wireless earpieces 302 in accordance with an illustrative embodiment. In one embodiment, the wireless earpieces 302 may enhance communications to a user. For example, the wireless earpieces 302 may provide high quality audio and audio sensing utilizing one or more graphene speakers and microphones as previously described.

As shown, the wireless earpieces 302 may be physically or wirelessly linked to each other and one or more electronic devices, such as cellular phones, virtual reality headsets, gaming systems, computers, smart glasses, smart watches, or so forth. User input and commands may be received from either of the wireless earpieces 302 (or other externally connected devices). As previously noted, the wireless earpieces 302 may be referred to or described herein as a pair (wireless earpieces) or singularly (wireless earpiece). The description may also refer to components and functionality of each of the wireless earpieces 302 collectively or individually.

The wireless earpieces 302 provide additional biometric and user data that may be further utilized by the any number of computing, entertainment, or communications devices. In some embodiments, the wireless earpieces 302 may act as a logging tool for receiving information, data, or measurements made by sensors of the wireless earpieces 302. For example, the wireless earpieces 302 may display pulse, blood oxygenation, position, orientation, distance, calories burned, and so forth as measured by the wireless earpieces 302. The wireless earpieces 302 may have any number of electrical configurations, shapes, and colors and may include various circuitry, connections, and other components.

In one embodiment, the wireless earpieces 302 may include a frame 304, a battery 308, a logic engine 310, a memory 312, user interface 314, physical interface 315, a transceiver 316, and sensors 312. The frame 304 is a lightweight and rigid structure for supporting the components of the wireless earpieces 302. In one embodiment, the frame 304 is formed from graphene layers or other carbon structures. The frame 304 may also be composed of any number of other polymers, plastics, composites, metals, or other combinations of materials suitable for personal use by a user. The battery 308 is a power storage device configured to power the wireless earpieces 302. In other embodiments, the battery 308 may represent a fuel cell, thermal electric generator, piezo electric charger, solar charger, ultra-capacitor, or other existing or developing power storage technologies.

The logic engine 310 is the logic that controls the operation and functionality of the wireless earpieces 302. The logic engine 310 may include circuitry, chips, and other digital logic. The logic engine 310 may also include programs, scripts, and instructions that may be implemented to operate the logic engine 310. The logic engine 310 may represent hardware, software, firmware, or any combination thereof. In one embodiment, the logic engine 310 may include one or more processors. The logic engine 310 may also represent an application specific integrated circuit (ASIC), system-on-chip (SOC) components, or field programmable gate array (FPGA). The logic engine 310 may be utilize information from the sensors 312 to determine the biometric information, data, and readings of the user. The logic engine 302 may utilize this information and other criteria to inform the user of the biometrics (e.g., audibly, through an application of a connected device, tactilely, etc.).

The logic engine 310 may also process user input to determine commands implemented by the wireless earpieces 302 or sent to the wireless earpieces 304 through the transceiver 316. The user input may be determined by the sensors 317 to determine specific actions to be taken. In one embodiment, the logic engine 310 may implement a macro allowing the user to associate user input (e.g., verbal, tactile, gesture, motion, etc.) as sensed by the sensors 317 with commands.

In one embodiment, a processor included in the logic engine 310 is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 312 is a hardware element, device, or recording media configured to store data for subsequent retrieval or access at a later time. The memory 312 may be static or dynamic memory. The memory 312 may include a hard disk, random access memory, cache, removable media drive, mass storage, or configuration suitable as storage for data, instructions, and information. In one embodiment, the memory 312 and the logic engine 310 may be integrated. The memory may use any type of volatile or non-volatile storage techniques and mediums. The memory 312 may store information related to the status of a user, wireless earpieces 302 and other peripherals, such as a wireless device, smart case for the wireless earpieces 302, smart watch, and so forth. In one embodiment, the memory 312 may display instructions or programs for controlling the user interface 714 including one or more LEDs or other light emitting components, speakers, tactile generators (e.g., vibrator), and so forth. The memory 312 may also store the user input information associated with each command.

In one embodiment, the processor may execute instructions stored in the memory. For example, the processor may process cell phone signals (e.g., voice input) into a format or electrical signals that may be amplified and converted by the graphene speaker into sound waves. The output of the wireless earpiece 300 may represent first signals (e.g., music, alerts, voice communications, etc.). The processor may also process electric signals received from the graphene microphone. For example, the graphene microphone may convert sound waves whether received through air or bone conduction, to electrical signals that may be communicated to the processor. For example, the processor may perform voice analysis or processing to determine whether an authentication, command, or other user input is received in the feedback or input received through the graphene microphone. The input received by the graphene microphone may represent second signals.

The transceiver 316 is a component comprising both a transmitter and receiver which may be combined and share common circuitry on a single housing. The transceiver 316 may communicate utilizing Bluetooth, Wi-Fi, ZigBee, Ant+, near field communications, wireless USB, infrared, mobile body area networks, ultra-wideband communications, cellular (e.g., 3G, 4G, 5G, PCS, GSM, etc.) or other suitable radio frequency standards, networks, protocols, or communications. The transceiver 316 may also be a hybrid transceiver that supports a number of different communications. For example, the transceiver 316 may communicate with a wireless device or other systems utilizing wired interfaces (e.g., wires, traces, etc.), NFC or Bluetooth communications.

The components of the wireless earpieces 302 may be electrically connected utilizing any number of wires, contact points, leads, busses, wireless interfaces, or so forth. In one embodiment, the frame 304 may include any of the electrical, structural, and other functional and aesthetic components of the wireless earpieces 302. For example, the wireless earpiece 302 may be fabricated with built in processors, chips, memories, batteries, interconnects, and other components that are integrated with the frame 304. For example, semiconductor manufacturing processes may be utilized to create the wireless earpiece 302 as an integrated and more secure unit. As a result, functionality, security, shock resistance, waterproof properties, and so forth may be enhanced. In addition, the wireless earpieces 302 may include any number of computing and communications components, devices or elements which may include busses, motherboards, circuits, chips, sensors, ports, interfaces, cards, converters, adapters, connections, transceivers, displays, antennas, and other similar components. The additional computing and communications components may also be integrated with, attached to, or part of the frame 304. The physical interface 315 is hardware interface of the wireless earpieces 302 for connecting and communicating with the wireless devices or other electrical components.

The physical interface 315 may include any number of pins, arms, or connectors for electrically interfacing with the contacts or other interface components of external devices or other charging or synchronization devices. For example, the physical interface 315 may be a micro USB port. In another embodiment, the physical interface 315 may include a wireless inductor for charging the wireless earpieces 302 without a physical connection to a charging device.

The user interface 314 is a hardware interface for receiving commands, instructions, or input through the touch (haptics) of the user, voice commands, or predefined motions. The user interface 314 may be utilized to control the other functions of the wireless earpieces 302. The user interface 314 may include the LED array, one or more touch sensitive buttons or portions, a miniature screen or display, or other input/output components. The user interface 314 may be controlled by the user or based on commands received from an external device or a linked wireless device. The user interface 314 may also include the graphene speakers or microphones 200 of FIG. 2. The graphene speakers and microphone may represent a single component or an array of components configured to communicate or receive distinct frequencies.

In one embodiment, the user may provide feedback by tapping the user interface 314 once, twice, three times, or any number of times. Similarly, a swiping motion may be utilized across or in front of the user interface 314 (e.g., the exterior surface of the wireless earpieces 302) to implement a predefined action. Swiping motions in any number of directions may be associated with specific activities, such as play music, pause, fast forward, rewind, activate a digital assistant (e.g., Siri, Cortana, smart assistant, etc.). The swiping motions may also be utilized to control actions and functionality of the wireless earpieces 302 or other external devices (e.g., smart television, camera array, smart watch, etc.). The user may also provide user input by moving her head in a particular direction or motion or based on the user's position or location. For example, the user may utilize voice commands, head gestures, or touch commands to change the content being presented audibly. The user interface 314 may include a camera or other sensors for sensing motions, gestures, or symbols provided as feedback or instructions.

The sensors 317 may include pulse oximeters, accelerometers, gyroscopes, magnetometers, inertial sensors, photo detectors, miniature cameras, and other similar instruments for detecting location, orientation, motion, and so forth. The sensors 317 may also be utilized to gather optical images, data, and measurements and determine an acoustic noise level, electronic noise in the environment, ambient conditions, and so forth. The sensors 317 may provide measurements or data that may be utilized to filter or select images or audio content. Motion or sound may be utilized, however, any number of triggers may be utilized to send commands to externally connected devices.

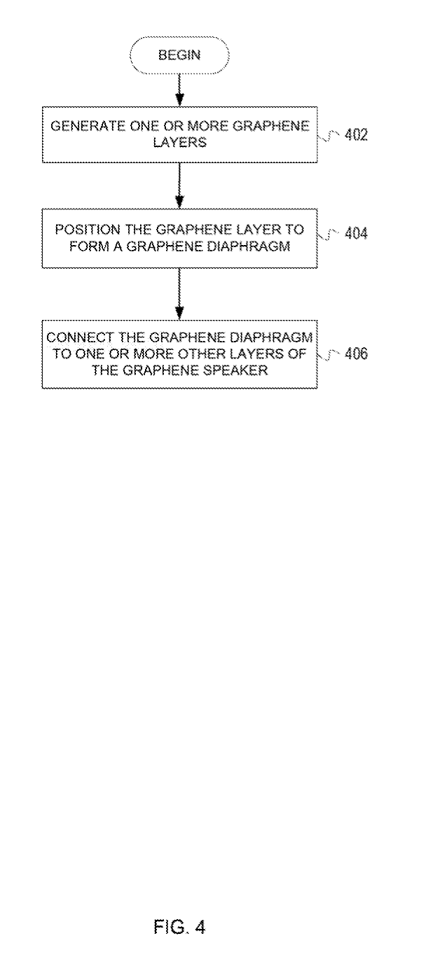

FIG. 4 is a flowchart of a process for generating a graphene speaker in accordance with an illustrative embodiment. The process of FIG. 4 may be implemented utilizing any number of devices, systems, equipment, facilities, or so forth (referred to generically as a “system”). For example, semiconductor manufacturing facilities and processes (or analogs) may be utilized. The process may be implemented automatically, semi-automatically, manually, or any combination thereof. The process of FIG. 4 may be implemented to generate a graphene speaker or array of graphene speakers. With minor modifications, the process may also be utilized to generate one or more graphene microphones.

The process may begin by generating one or more graphene layers (step 402). The graphene layers may be generated one at a time (or utilizing another carbon structure or material). The graphene layers may be generated utilizing any number of processes or in any number of environments, such as chemical vapor deposition, epitaxial growth, nano-3D printing, or the numerous other methods being developed or currently utilized. In one embodiment, the graphene layers may be generated on a substrate or other framework that may make up one or more portions of the wireless earpieces.

Next, the system positions the graphene layer to form a graphene diaphragm (step 404). In one embodiment, a single graphene layer may be positioned. For example, the graphene layer may be positioned over a frame or structure of the speaker or microphone to form a graphene diaphragm. The graphene layer may be mechanically, chemically, or otherwise bound to a frame that makes up the graphene diaphragm. For example, the graphene layer may be bonded to the frame utilizing an adhesive. During step 404, the graphene layer may also be trimmed or otherwise shaped to a desired shape and size. In another embodiment, the graphene layers may be layered on top of each other or otherwise positioned. In one embodiment, graphene layers may be bonded to another substrate or material to enhance the effectiveness of the graphene at blocking cerumen, water, or other materials while enhancing strength, rigidity, and other properties of the wireless earpiece (e.g., portion of the frame corresponding to the sleeve fitting in the ear of the user).

Next, the system connects the graphene diaphragm to one or more other layers of the graphene speaker (step 406). The graphene diaphragm may represent one of a number of layers, circuits, components, and structures of the graphene speaker. For example, the graphene diaphragm may be connected to one or more electrode layers, spacers, supporting frames, electronics layers (e.g., amplifiers, signal processors, filters, chips, etc.) and so forth. For example, the graphene diaphragm may be generated and layered utilizing semiconductor manufacturing processes. In one embodiment, wires or leads (e.g., gold wires, integrated traces, etc.) may be connected to electrodes of the graphene diaphragm to convert electronic signals to sound waves. The process of FIG. 4 may be utilized to generate one or more graphene speakers for wireless earpieces. The one or more layers may be mechanically, structurally, or chemically secured together or to another framework. The graphene may be produced in sheets, meshes, or framework. The process may also be utilized to generate other carbon-based or micro speakers and microphones. In one embodiment, the process of FIG. 4 is utilized to generate a graphene microphone where the graphene diaphragm senses sound waves received though air or ear-bone conduction.

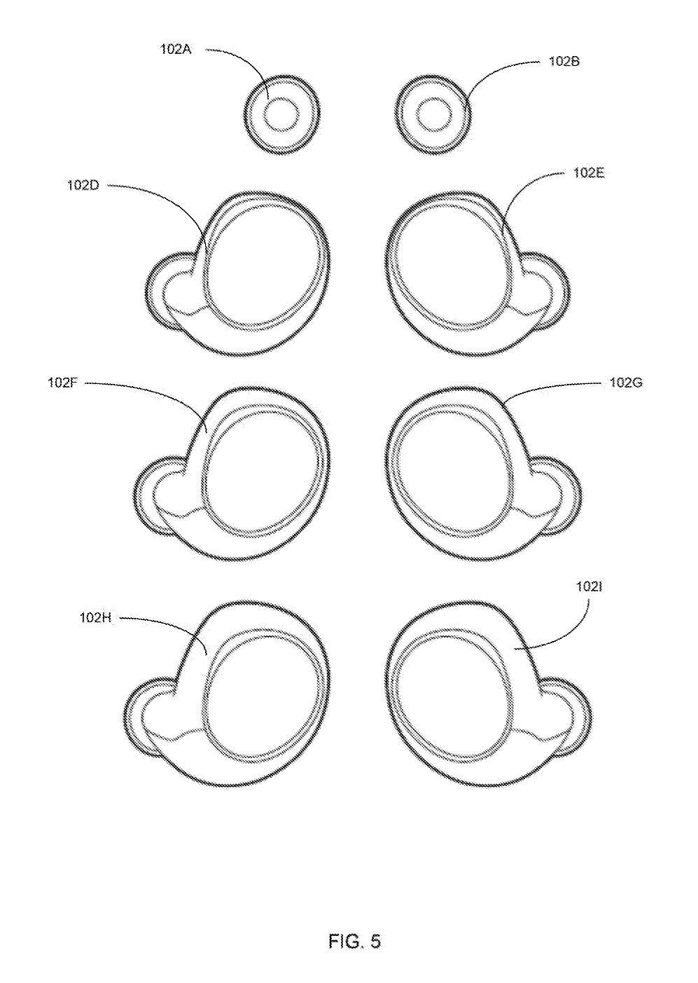

FIG. 5 illustrates different sizes of sleeves that may be used to fit different users. These include extra small sizes 102A, 102B; small sizes 102D, 102E, medium 102F, 102G, and large 102H, 102I. The sizes shown are merely representative and other sizes may be used. It is also to be understood that the shape of the sleeve is related to the ear piece on which it fits. In addition, it is contemplated that sleeves may come in standard sizes or custom sizes such as when they are fitted to specific individuals.

The illustrative embodiments are not to be limited to the particular embodiments described herein. In particular, the illustrative embodiments contemplate numerous variations in the type of ways in which embodiments may be applied. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A wireless earpiece, comprising:
a frame supporting circuitry of the wireless earpiece,
wherein the frame includes a graphene speaker and a graphene microphone within a sleeve portion of the frame configured to fit in to the ear canal of a user.

2. The wireless earpiece of claim 1, wherein the graphene speaker and the graphene microphone each utilize a graphene diaphragm.

3. The wireless earpiece of claim 2, wherein the graphene diaphragm is printed utilizing a three dimensional printer.

4. The wireless earpiece of claim 2, wherein layers of graphene are layered to form the graphene diaphragm.

5. The wireless earpiece of claim 1, wherein the graphene speaker and the graphene microphone include one or more electrode layers and spacer layers.

6. The wireless earpiece of claim 1, wherein the sleeve is formed of silicone.

7. The method of claim 1, wherein the graphene speaker and the graphene microphone utilize earbone conduction of sound waves.

8. The method of claim 1, wherein the wireless earpiece includes a plurality of speakers including the speaker each optimized for a plurality of distinct frequencies.

9. The method of claim 1, wherein the graphene microphone utilizes ear-bone conduction to convert sound waves to electrical signals for processing by the wireless earpiece.

10. The method of claim 1, wherein the housing of the speaker is formed from graphene.

11. A wireless earpiece comprising:
a frame supporting circuitry of the wireless earpiece,
a graphene speaker that converts first electronic signals to first sound waves;
a graphene microphone that converts second sound waves to second electronic signals;
a processor for executing a set of instructions; and
a memory for storing the set of instructions, wherein the set of instructions are executed to:
process the first electronic signals for playback by the graphene speaker; and
process the second electronic signals received from the graphene microphone.

12. The wireless earpiece of claim 11, wherein the graphene speaker and the graphene microphone each utilize a graphene diaphragm.

13. The wireless earpiece of claim 12, wherein layers of graphene are layered to form the graphene diaphragm.

14. The wireless earpiece of claim 11, wherein the wireless earpiece includes a plurality of speakers including the speaker each optimized for a plurality of distinct frequencies.

15. A method for forming a graphene speaker for a wireless earpiece, comprising:
creating a graphene layer;
securing the graphene layer within a frame to form a graphene diaphragm;
connecting the graphene diaphragm to a plurality of layers to create the graphene speaker.

16. The method of claim 15, further comprising:
connecting at least an electrode layer and a spacer layer to the graphene diaphragm.

17. The method of claim 15, further comprising:
securing the graphene speaker within a framework of a wireless earpiece.

18. The method of claim 15, further comprising:
connecting a plurality of electrodes to the graphene diaphragm; and
connecting the graphene diagram to a signal generator utilizing the electrodes.

19. The method of claim 15, wherein the graphene diaphragm includes a plurality of graphene layers.

20. The method of claim 15, wherein the graphene speaker utilizes earbone conduction of sound waves.
